(19) United States
(12) Patent Application Publication
(10) Pub. No.: US 2019/0287217 A1
(43) Pub. Date: Sep. 19, 2019

(54) MACHINE LEARNING SYSTEM FOR REDUCED NETWORK BANDWIDTH TRANSMISSION OF CONTENT

(71) Applicant: Microsoft Technology Licensing, LLC, Redmond, WA (US)

(72) Inventors: Simon Lee COOKE, Seattle, WA (US); David Scott McCOY, Bellevue, WA (US)

(21) Appl. No.: 15/936,782

(22) Filed: Mar. 27, 2018

Related U.S. Application Data
(60) Provisional application No. 62/642,593, filed on Mar. 13, 2018.

(51) Int. Cl. G06T 3/40; H04B 1/66

(52) U.S. Cl. CPC G06T 3/4076; H04B 17/3913; H04B 1/66

(57) ABSTRACT

A decoder network is trained to regenerate content based upon latent vectors associated with the content. The trained decoder network is pre-deployed to a device. The device can make a request to a second device for the content. Responsive to receiving such a request, the decoder network is utilized to create a first version of the original content using the latent vectors for the content. A delta, or residual, can also be computed between the first version of the content and the original content. The latent vectors and delta are transmitted to the device. The decoder network on the device utilizes the latent vectors to generate another first version of the original content. The delta is applied to the first version of the original content to generate a second version of the original content having a higher quality than the version of the original content generated by the decoder network.

### CROSS-REFERENCE TO RELATED APPLICATIONS

This application claims the benefit of U.S. provisional patent application No. 62/642,593, which was filed on Mar. 13, 2018 and is entitled “MACHINE LEARNING SYSTEM FOR REDUCED NETWORK BANDWIDTH TRANSMISSION OF CONTENT,” the contents of which are expressly incorporated herein by reference in their entirety.

### BACKGROUND

The performance of many different types of computing devices continues to improve, generation after generation. For example, the processing capability of server computers, desktop computers, laptops, tablets, and smartphones continues to improve, and will likely do so for the foreseeable future. Advances in processing and storage capability allow these types of devices to process and utilize ever larger amounts of data. For example, it is not unusual for some application programs, complex video games for instance, to utilize hundreds of gigabytes (“GB”) of program code, audio files, images, text, video, textures, and other types of content.

The various hardware components utilized in many types of computing devices continue to evolve in order to support processing and storage of large amounts of data. For example, the capability of processors, memory devices, mass storage devices, and graphics processing units have evolved quickly, and continue to do so, to support the processing of large amounts of data. In many cases, however, network performance has not evolved quickly enough to efficiently support the transmission of many hundreds of gigabytes of data, such as currently required by complex video games and other types of programs.

It is with respect to these and other technical challenges that the disclosure made herein is presented.

### SUMMARY

A computer-implemented machine learning system is disclosed that can reduce the amount of network bandwidth required to transmit digital content, such as audio, images, text, video, textures, and other types of data, between two computing devices. The performance of computing devices implementing the disclosed technologies can be improved by reducing the amount of network bandwidth, and therefore time, required to transmit content between the computing devices. Because the transmission time is reduced, the utilization of other types of computing resources, such as processor cycles, power, memory, and potentially others, can also be reduced. Other technical benefits not specifically mentioned herein can also be realized through implementations of the disclosed subject matter.

In order to realize the technical benefits mentioned briefly above, machine learning techniques are utilized to train an encoder network to efficiently generate latent vectors associated with content, such as images, video, audio, or text, for example. Machine learning techniques are also utilized to train a decoder network to generate a new version of original content from the latent vectors associated with the original content. The content generated by the decoder network might be referred to herein as a “first version” of the original content or as “generated content.” In some embodiments, a variational autoencoder generative adversarial network (“VAE-GAN”) is utilized to train the encoder network and the decoder network.

Once the decoder network has been trained, the trained decoder network can be deployed to a computing device to which content will be transmitted (i.e. a “destination” computing device). In one specific example, for instance, the trained decoder network is deployed to a video game console or another type of computing device to which content will be transmitted. The trained decoder network can be pre-deployed to the computing device by storing the trained decoder network on a mass storage device in the device at manufacturing time. The trained decoder network can be pre-deployed to a destination computing device in other ways in other embodiments.

Following deployment of the trained decoder network to the destination computing device, the trained decoder network can be utilized to efficiently transmit content from a source computing device (e.g. a server computer) to the destination computing device. For example, in one particular embodiment, a destination computing device can request content, such as such an image, video, audio, or text, from the source computing device.

Responsive to receiving a content request, the source computing device can execute the trained encoder network to generate latent vectors for the requested original content. The source computing device can also execute the trained decoder network to generate a version of the requested original content from the latent vectors. The source computing device can also compute a residual, or delta, between the original content and the version of the original content generated by the trained decoder network. In some embodiments, the latent vectors and delta are generated and stored prior to receiving content requests from the destination computing device.

The source computing device can then transmit the latent vectors associated with the original content and the delta between the original content and the generated content to the destination computing device. The latent vectors and the delta can be transmitted to the destination computing device over a communications network, such as the Internet for example. The latent vectors and the delta are smaller in size than the original content. In some embodiments, the latent vectors are compressed using lossless compression prior to transmission. The delta can also be compressed using lossless or lossy compression prior to transmission in some embodiments.

The destination computing device executes the pre-deployed trained decoder network, which utilizes the latent vectors associated with the original content to generate another first version of the original content. The destination computing device then applies the delta received from the source computing device to the generated content in order to create a second version of the original content. The second version of the original content generated at the destination computing device might also be referred to herein as “regenerated content.” The regenerated content is of a higher quality than the first version of the content generated by the trained decoder network.

As discussed briefly above, implementations of the technologies disclosed herein, can reduce the utilization of network bandwidth and, therefore, reduce the utilization of processor cycles, power, and potentially other types of computing resources. Other technical benefits not specifically identified herein can also be realized through implementations of the disclosed technologies.

It should be appreciated that the above-described subject matter can be implemented as a computer-controlled apparatus, a computer-implemented method, a computing device, or as an article of manufacture such as a computer readable medium. These and various other features will be apparent from a reading of the following Detailed Description and a review of the associated drawings.

This Summary is provided to introduce a brief description of some aspects of the disclosed technologies in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a computer system architecture diagram showing aspects of a machine learning system that enables reduced network bandwidth transmission of content, according to one embodiment;

FIG. 2 is a software architecture diagram showing aspects of one mechanism for training an encoder network and a decoder network in a machine learning system that enables reduced network bandwidth transmission of content, according to one embodiment;

FIG. 3 is a software architecture diagram showing aspects of the runtime operation of a machine learning system that enables reduced network bandwidth transmission of content, according to one embodiment;

FIG. 4 is a data structure diagram showing an illustrative original image, generated image, delta, and regenerated image generated by the disclosed machine learning system for reducing network bandwidth used to transmit content, according to one embodiment;

FIG. 5 is a flow diagram showing a routine that illustrates aspects of the operation of the machine learning system illustrated in FIGS. 1-4 that enables reduced network bandwidth transmission of content, according to one embodiment disclosed herein;

FIG. 6 is a computer architecture diagram showing an illustrative computer hardware and software architecture for a computing device, such as the computing devices shown in FIGS. 1-3, that can implement aspects of the technologies presented herein;

FIG. 7 is a network diagram illustrating a distributed computing environment capable of implementing aspects of the technologies presented herein; and

FIG. 8 is a computer architecture diagram illustrating a computing device architecture for a computing device, such as the computing devices shown in FIGS. 1 and 3, that is capable of implementing aspects of the technologies presented herein.

### DETAILED DESCRIPTION

The following detailed description is directed to a computer-implemented machine learning system that can reduce the network bandwidth required to transmit content between computing devices. As discussed briefly above, the performance of computing devices implementing the disclosed technologies can be improved by reducing the amount of network bandwidth required to transmit content between the computing devices. Because the amount of bandwidth utilized is reduced, the utilization of other types of computing resources, such as processor cycles and power, can also be reduced. Other technical benefits not specifically mentioned herein can also be realized through implementations of the disclosed subject matter.

While the subject matter described herein is presented in the general context of program modules that execute in conjunction with the execution of an operating system and application programs on a computer system, those skilled in the art will recognize that other implementations can be performed in combination with other types of program modules. Generally, program modules include routines, programs, components, data structures, and other types of structures that perform particular tasks or implement particular abstract data types. Moreover, those skilled in the art will appreciate that the subject matter described herein can be practiced with other computer system configurations, including hand-held devices, multiprocessor systems, microprocessor-based or programmable consumer electronics, computing or processing systems embedded in devices (such as wearables, automobiles, home automation etc.), minicomputers, mainframe computers, and the like.

In the following detailed description, references are made to the accompanying drawings that form a part hereof, and which are shown by way of illustration specific configurations or examples. Referring now to the drawings, in which like numerals represent like elements throughout the several FIGS., aspects of a machine learning system that provides reduced network bandwidth transmission of content will be described.

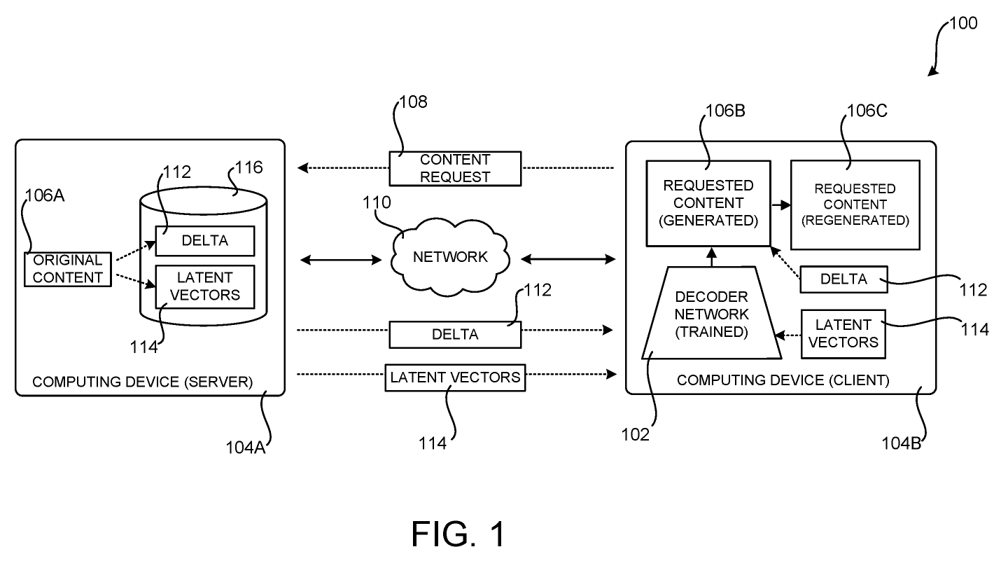

FIG. 1 is a computer system architecture diagram showing aspects of a machine learning system 100 capable of reducing the network bandwidth utilized to transmit content between two computing devices, according to one embodiment. As shown in FIG. 1, the system 100 includes a first computing device 104A, which might be referred to herein as a server or source computing device 104A, and a second computing device 104B, which might be referred to herein as a client or destination computing device 104B.

The computing devices 104A and 104B might be server computers, desktop computers, laptop computers, tablet computers, smartphones, video game consoles, smartphones, or other types of computing devices suitable for executing the software components presented herein. The computing device 104A and the computing device 104B are connected by way of a data communications network 110, such as a local area network (“LAN”) or a wide area network (“WAN”), such as the Internet.

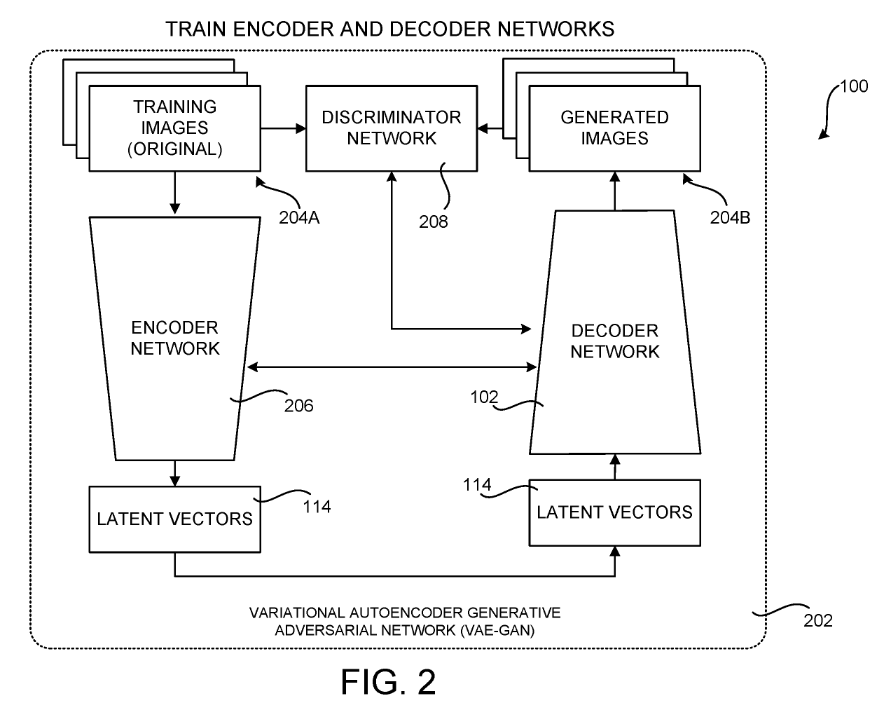

As will be described in greater detail below with regard to FIG. 2, machine learning techniques are utilized to train an encoder network (not shown in FIG. 1) to efficiently generate latent vectors 114 associated with content 106A, such as images, video, audio, or text, for example. Machine learning techniques are also utilized to train a decoder network 102 to generate a new version of the original content 106A from the latent vectors 114 associated with the original content 106A.

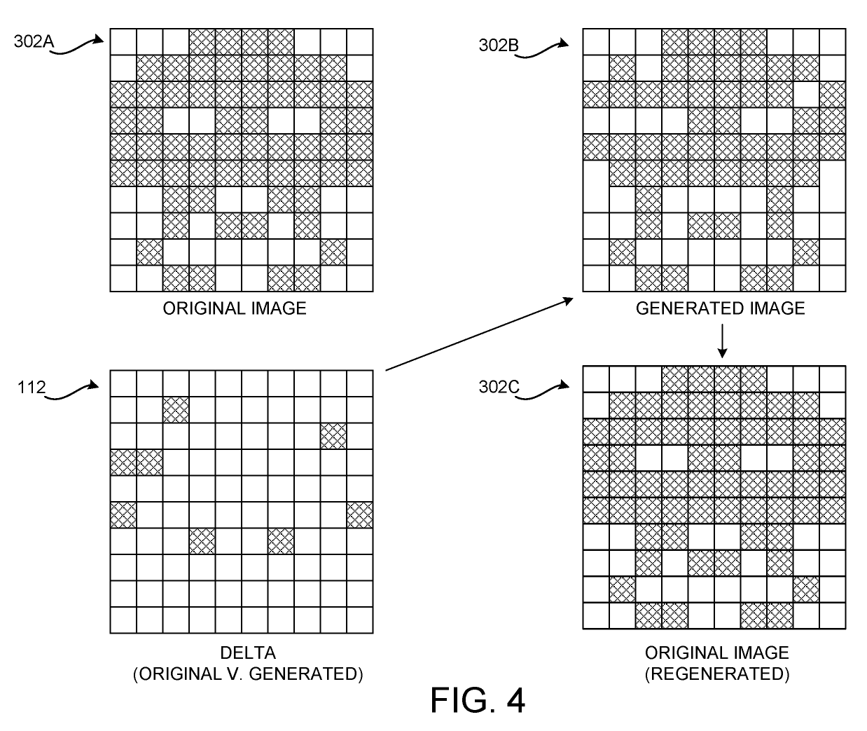

The content 106B generated by the decoder network 102 might be referred to herein as a “first version” of the original content 106A or as “generated content 106B.” In some embodiments, a variational autoencoder generative adversarial network (“VAE-GAN”) is utilized to train the encoder network and the decoder network 102. Additional details regarding one illustrative process for training the encoder network and the decoder network 102 will be provided below with regard to FIGS. 2 and 4.

Once the decoder network 102 has been trained, the trained decoder network 102 can be deployed to the destination computing device 104B. For instance, the trained decoder network 102 might be pre-deployed to the destination computing device 104B by storing the trained decoder network 102 on a mass storage device (not shown in FIG. 1) in the destination computing device 104B at manufacturing time of the destination computing device 104B.

The trained decoder network 102 can be pre-deployed to the destination computing device 104B in other ways in other embodiments. For example, and without limitation, the trained decoder network 102 can be shipped on a disk, deployed as part of a system update, embedded in a computing system firmware, or shipped with a software package. The trained decoder network 102 might also be provided at runtime. For example, for a video call, the trained decoder network 102 might be transmitted at the start of the call that regenerates the face of a person on the call. This could either be a set of modifications applied to a generalized decoder the user already has, or a separate one entirely.

Following deployment of the trained decoder network 102 to the destination computing device 104B, the trained decoder network 102 can be utilized to efficiently transmit content 106A from the source computing device 104A (e.g. a server computer) to the destination computing device 104B (e.g. a video game console). For example, in one particular embodiment, the destination computing device 104B can transmit a request 108 for content 106A, such as such an image, video, audio, or text, to the source computing device 104A. In this regard, it is to be appreciated that a content request 108 is not required by the embodiments disclosed herein. For example, a ‘push’ mechanism that does not require a request 108 might be utilized in some embodiments to push content from the source computing device 104A to the destination computing device 104B.

Responsive to receiving a content request 108, the source computing device 104A can execute the trained encoder network (not shown in FIG. 1) to generate latent vectors 114 for the requested original content 106A. The source computing device 104A can also execute the trained decoder network 102 to generate a version of the requested original content 106A from the latent vectors 114.

The source computing device 104A can also compute a residual, or delta 112, that identifies the differences between the original content 106A and the version of the original content generated by the trained decoder network 102. In some embodiments, the latent vectors 114 and delta 112 are generated and stored in an appropriate data store 116 prior to receiving content requests 108 from the destination computing device 104B.

The source computing device 104A can then transmit the latent vectors 114 associated with the original content 106A and the data describing the delta 112 between the original content 106A and the generated content to the destination computing device 104B. The latent vectors 114 and the delta 112 can be transmitted to the destination computing device 104B over a communications network 110, such as a LAN or a WAN, like the Internet.

In some embodiments, the latent vectors 114 are compressed using lossless compression prior to transmission to the destination computing device 104B. The delta 112 can also be compressed using lossless or lossy compression prior to transmission to the destination computing device 104B in some embodiments. Because the latent vectors 114 and the delta 112 are smaller in size than the original content 106A, network bandwidth can be saved as compared to transmitting the original content 106A itself

The destination computing device 104B executes the pre-deployed trained decoder network 102. The trained decoder network 102 utilizes the latent vectors 114 associated with the original content 106A received from the source computing device 104A to generate another first version 106B of the original content 106A. The destination computing device 104B then applies the delta 112 received from the source computing device 104A to the generated content 106B to create a second version 106C of the original content 106B.

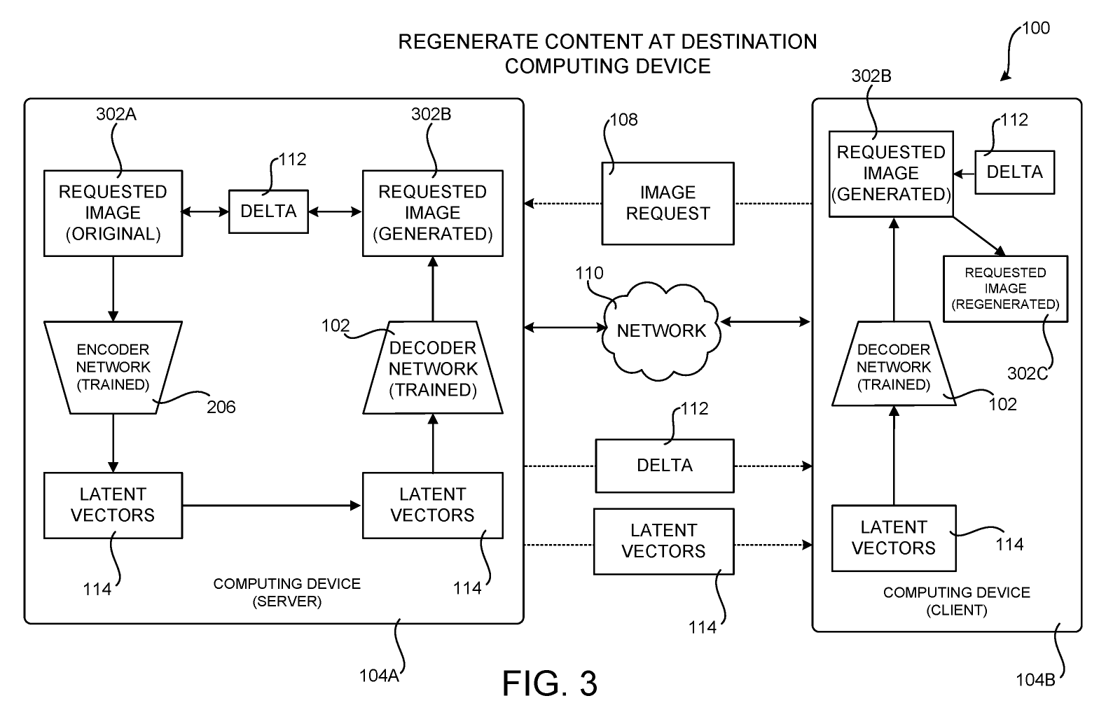

As mentioned above, the second version 106C of the original content 106A generated at the destination computing device 104B might also be referred to herein as “regenerated content 106C.” The regenerated content 106C is of a higher quality than the generated content 106B produced by the trained decoder network 102 using the latent vectors 114. Additional details regarding the runtime process for regenerating the original content 106A at the destination computing device 104B will be provided below with regard to FIGS. 3-5.

FIG. 2 is a software architecture diagram showing aspects of one mechanism for training an encoder network 206 and a decoder network 102 in a machine learning system 100 that enables reduced network bandwidth transmission of content, according to one embodiment. As described briefly above, the encoder network 206 and the decoder network 102 are trained using a variational autoencoder (“VAE”) generative adversarial network (“GAN”), together “VAE-GAN 202,” in some embodiments disclosed herein.

The VAE portion of the VAE-GAN 202 includes the encoder network 206, the decoder network 102, and a loss function, each of which is described in detail below. The encoder network 206 is a deep neural network in one embodiment that takes the content 106A as its input. The encoder network 206 ‘encodes’ the content 106A into a latent (i.e. hidden) representation space, referred to herein as a “latent representation” or “latent vectors 114.” The encoder network 206 might, for example, be implemented as one or more hidden convolution layers and a fully connected output layer.

The latent vectors 114 generated by the encoder network 206 have a lower dimensionality than the content 106A input into the encoder network 206. For example, the input to the encoder network might be a 28 by 28-pixel input image, which is 784-dimensional. The latent representation of the input image is much less than 784-dimensional. The lower dimensionality of the latent vectors 114 causes the encoder network 206 to learn an information-rich compression of the raw input data as it maps the content 106A to the latent representation space.

The decoder network 102 is also a deep neural network in one embodiment. The decoder network 102 takes the latent vectors 114 (i.e. the latent representation of the content 106A) and uses the latent vectors 114 to reconstruct the original content 106A. The decoder network 102 might, for example, be implemented as a fully connected input layer and one or more hidden deconvolution layers.

Information is lost during decoding because the latent vectors 114 are of a lower dimensional space than the content 106A output by the decoder network 102. For instance, in the example given above, the latent vectors 114 can be utilized to generate an output representing each of the pixels of a 28 by 28-pixel image (i.e. a 784-dimensional output). Accordingly, a loss function can be defined that measures how effectively the decoder network 102 has learned to reconstruct input content 106A given its latent representation (i.e. the latent vectors 114). As will be described in greater detail below, the machine learning system 100 is trained end-to-end: the encoder network 206 learns the most important features of the input content 106A, allowing the decoder network 102 to reconstruct the input content 106A from the latent vector representation.

The GAN portion of the VAE-GAN 202 is comprised of two networks: a generator network and a discriminator network 208. The function of the generator network is to produce output that fools the discriminator network 208. The function of the discriminator network 208 is to correctly distinguish between “real” and “fake” input (in this case, to distinguish real content 106A from generated content 106B). In the illustrative machine learning system 100 disclosed herein, the decoder network 102 acts as the generator network. A discriminator network 208 is added to the VAE to form the VAE-GAN 202 shown in FIG. 2. The discriminator network 208 might, for example, be implemented as one or more hidden convolution layers and a fully connected output layer.

In the embodiment illustrated in FIG. 2, the encoder network 206 is trained using training images 204A. The images used for training can include a broad set of images representative of the kinds of images that will be later transmitted. In this regard, it is to be appreciated while FIG. 2 illustrates training of the VAE-GAN 202 on the images 204A, the same mechanism can be utilized to train the VAE-GAN 202 on other types of content such as, but not limited to, video, audio, and text. Accordingly, the embodiments disclosed herein are not to be read as limiting the disclosed technologies to use with images or any other type of content.

It is to be further appreciated that while the embodiments disclosed herein are presented primarily in the context of a VAE-GAN, other types of networks can be utilized in other embodiments to train the encoder network 206 and decoder network 102. For example, and without limitation, an adversarial autoencoder (“AAE”) can be used in other embodiments to train the encoder network 206 and the decoder network 102.

As shown in FIG. 2, the encoder network 206 generates latent vectors 114 for the input images 204A. The latent vectors 114 are then fed to the decoder network 102 during training. The decoder network 102, in turn, generates new images (i.e. the “generated images 204B”) from the latent vectors 114.

The discriminator network 208 receives both the original training images 204A (i.e. the “real” images) and the corresponding generated images 204B (i.e. the “fake” images). The discriminator network 208 then returns a probability for each generated image 204B that the generated image 204B is fake.

Both the decoder network 102 and the discriminator network 208 try to optimize a loss function describing the differences between the input images 204A and the generated images 204B. As the discriminator network 208 changes its behavior, so does the generator network 206, and vice versa.

It is to be appreciated that, in some embodiments, one or more “fitness functions” operating on the delta between the original and the new version of the image can be used in place of the discriminator network 208. One of the fitness functions measures how well the delta data compresses. For example, if a reconstructed image was just a 20% brighter version of the original image, that delta would compress very well. Various lossless compression algorithms could be applied to the delta—e.g. arithmetic compression, RLE compression, or LZ. The amount of compression vs. the original image gives a measure of fitness for the network in generating the representation. Another alternative is to perform a least-squared difference between every pixel in the original image and the representation Σ(O_{xy}−R_{xy})². The lower the values, the better the fit. Combinations of these mechanisms can also be used to obtain multiple measures of fitness for training

Once the encoder network 206 and the decoder network 102 have been trained in the manner described above, the trained decoder network 102 can be deployed to the destination computing device 104B. For instance, the trained decoder network 102 might be pre-deployed to the destination computing device 104B by storing the trained decoder network 102 on a mass storage device in the destination computing device 104B at manufacturing time of the destination computing device 104B. The trained decoder network 102 can be pre-deployed to the destination computing device 104B in other ways in other embodiments.

The trained encoder network 206 and trained decoder network 102 can also be executed on the source computing device 104A. For example, these components might be executed on a server computer in some embodiments. As will be described in greater detail below, the trained encoder network 206 and trained decoder network 102 can be utilized to reduce the amount of bandwidth required to transmit content from the source computing device 104A to the destination computing device 104B.

FIG. 3 is a software architecture diagram showing aspects of the runtime operation of a machine learning system 100 that enables reduced network bandwidth transmission of content, according to one embodiment. The disclosed technologies are also utilized to transmit images in the embodiment shown in FIG. 3. As discussed above, however, this mechanism can be utilized to transmit other types of content, such as video or audio, in other embodiments.

As discussed briefly above, following deployment of the trained decoder network 102 to the destination computing device 104B, the trained decoder network 102 can be utilized to efficiently transmit content 106A from the source computing device 104A (e.g. a server computer) to the destination computing device 104B (e.g. a video game console). For example, in one embodiment, the destination computing device 104B can transmit a request 108 for content, such as such an image (i.e. the “requested image 302A”) to the source computing device 104A.

Responsive to receiving a request 108 for the image 302A, the source computing device 104A can execute the trained encoder network 206 to generate latent vectors 114 for the requested image 302. The source computing device 104A can also execute the trained decoder network 102 to generate a version (i.e. the generated image 302B) of the requested image 302A from the latent vectors 114.

The source computing device 104A can also compute a residual, or delta 112, that identifies the differences between the requested image 302A and the generated image 302B created by the trained decoder network 102 using the latent vectors 114. The delta 112 can be generated by subtracting the generated image 302B from the requested image 302A. The delta 112 is then compressed for transmission as noted below.

As discussed above with regard to FIG. 1, the latent vectors 114 and delta 112 are generated and stored in an appropriate data store 116 prior to receiving content requests 108 from the destination computing device 104B in some embodiments.

The source computing device 104A can then transmit the latent vectors 114 associated with the requested image 302A and the data describing the delta 112 between the requested image 302A and the generated image 302B to the destination computing device 104B. As discussed above, the latent vectors 114 and the delta 112 can be transmitted from the source computing device 104A to the destination computing device 104B over a communications network 110, such as a LAN or a WAN, like the Internet.

In some embodiments, the latent vectors 114 are compressed using lossless or lossy compression prior to transmission to the destination computing device 104B. The delta 112 can also be compressed using lossless or lossy compression prior to transmission to the destination computing device 104B in some embodiments. Because the latent vectors 114 and the delta 112 are smaller in size than the requested image 302A, network bandwidth can be saved as compared to transmitting the requested image 302A, or other type of content, itself.

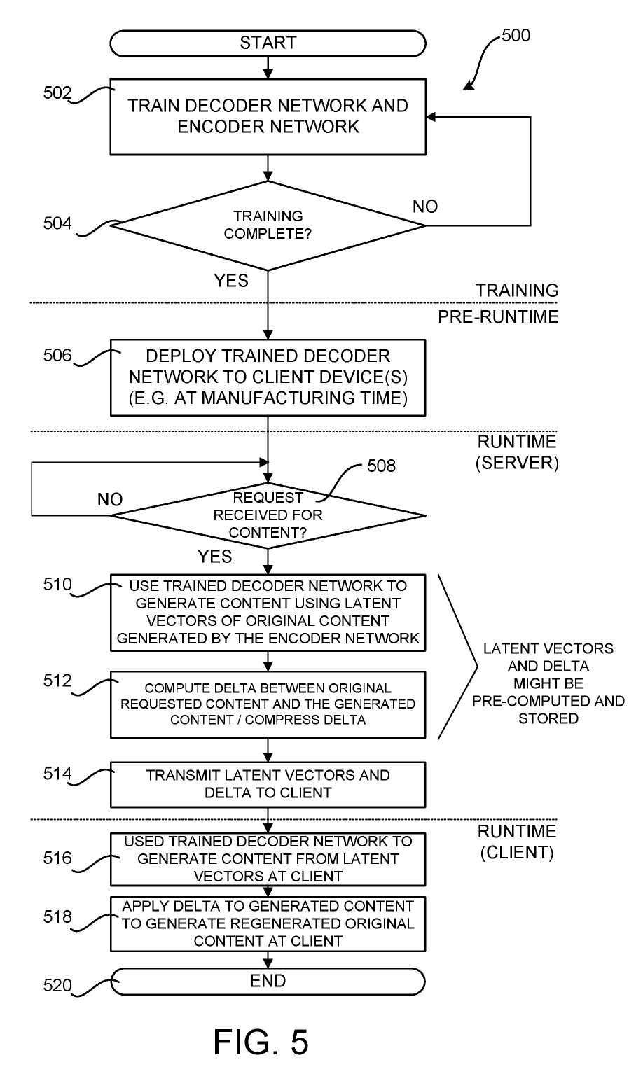

The destination computing device 104B executes the pre-deployed trained decoder network 102. When executed, the trained decoder network 102 utilizes the latent vectors 114 associated with the requested image 302A to generate another version (i.e. the generated image 302B) of the requested image 302A. The destination computing device 104B then decompresses the delta 112 and applies the delta 112 received from the source computing device 104A to the generated image 302B to create the regenerated image 302C such as, for example, by adding the delta to the generated image 302B. Application of the delta 112 to the generated image 302B results in a regenerated image 302C that is of higher quality than the generated image 302B produced by the trained decoder network 102 using the latent vectors 114. This process is illustrated further with respect to FIGS. 4 and 5, below.

FIG. 4 is a data structure diagram showing an illustrative requested image 302A, a generated image 302B, delta 112, and regenerated image 302C generated by the disclosed machine learning system 100 for reducing network bandwidth used to transmit content, according to one embodiment. In the example shown in FIG. 4, the destination computing device 104B has requested an image 302A showing an alien, such as might be utilized in a video game. The requested image 302A is a 10 by 10-pixel black and white image in this example.

As discussed above, the encoder network 206 can take the requested image 302A as input and generate latent vectors 114 for the requested image 302A that have a lower dimensionality than the image 302A itself (e.g. less than 100 dimensions in this example). The latent vectors 114 for the requested image 302A can then be passed to the decoder network 102 which, in turn, creates the generated image 302B using the latent vectors 114. In the example shown in FIG. 4, for instance, the generated image 302B is similar, but not identical, to the requested image 302A. In particular, eight pixels in the generated image 302B are different than the corresponding pixels in the original image 302A.

As also discussed above, the source computing device 104A performs a comparison between the requested image 302A and the generated image 302B to determine the delta 112 between the two images. In the example shown in FIG. 4, the delta 112 identifies the eight pixels that are different between the requested image 302A and the generated image 302B. The latent vectors 114 and the delta 112 are transmitted to the destination computing device 104B.

The destination computing device 104B receives the delta 112 and the latent vectors 114. The destination computing device 104B executes the pre-deployed trained decoder network 102 which, in turn, generates the image 302B from the latent vectors 114. The destination computing device 104B then applies the delta 112 to the generated image 302B to obtain the regenerated image 302C.

In the example shown in FIG. 4, the delta 112 fixes the eight incorrect pixels in the generated image 302B to result in a regenerated image 302C that is identical to the requested image 302A. It is to be appreciated, however, that the regenerated image 302C may not be identical to the original image 302A in an actual implementation of the disclosed technologies.

FIG. 5 is a flow diagram showing a routine 500 that illustrates aspects of the operation of the machine learning system 100 illustrated in FIGS. 1-4 and described above, according to one embodiment disclosed herein. It should be appreciated that the logical operations described herein with regard to FIG. 5, and the other FIGS., can be implemented (1) as a sequence of computer implemented acts or program modules running on a computing device and/or (2) as interconnected machine logic circuits or circuit modules within the computing device.

The particular implementation of the technologies disclosed herein is a matter of choice dependent on the performance and other requirements of the computing device. Accordingly, the logical operations described herein are referred to variously as states, operations, structural devices, acts, or modules. These states, operations, structural devices, acts and modules can be implemented in software, in firmware, in special purpose digital logic, and any combination thereof. It should also be appreciated that more or fewer operations can be performed than shown in the FIGS. and described herein. These operations can also be performed in a different order than those described herein.

The routine 500 begins at operation 502, where the encoder network 206 and the decoder network 102 are trained in the manner described above with regard to FIG. 2. Once the encoder network 206 and the decoder network 102 have been trained, the routine 500 proceeds from operation 504 to operation 506, where the trained decoder network 102 can be deployed to client devices, such as the destination device 104B described above. As discussed above, the decoder network 102 can be pre-deployed to these devices, such as during manufacturing time. In this manner, the decoder network 102 does not need to be transmitted to the client devices over a WAN like the Internet or another type of network.

Once the decoder network 102 has been deployed, the routine 500 proceeds from operation 506 to operation 508, where the source computing device 104A determines whether a request 108 has been received for content 106A in one embodiment. If such a request 108 has been received, the routine 500 proceeds from operation 508 to operation 510, where the trained decoder network 102 is utilized to generate content 106B utilizing the latent vectors 114 for the requested content 106A generated by the encoder network 206.

The routine 500 then proceeds from operation 510 to operation 512, where the delta 112 between the requested content 106A and the generated content 106B is computed. As discussed above, the latent vectors 114 and delta 112 can be pre-computed and stored prior to receiving requests 108 for the content from the destination computing device 104B in some embodiments. From operation 512, the routine 500 proceeds to operation 514, where the latent vectors 114 and the delta are transmitted to the destination computing device 104B.

From operation 514, the routine 500 proceeds to operation 516, where the destination computing device 104B executes the trained decoder network 102 to generate a version 106B of the requested content 106A from the received latent vectors 114 associated with the content 106A. The routine 500 then proceeds from operation 516 to operation 518, where the destination computing device 104B applies the delta 112 to the generated content 106B to create the regenerated content 106C at the destination computing device 104B. The routine 500 then proceeds from operation 518 to operation 520, where it ends.

It is to be appreciated that while the embodiments disclosed herein have been presented primarily in the context of processing entire images, the technologies disclosed herein can be similarly applied to masked-off or “sliced up” portions of images, different resolution versions of the original image (i.e. resize by 50%, then resize again), or other techniques may be applied (e.g. edge detection). The techniques are then applied in reverse during reconstruction of the original image. These operations might also be applied to multiple instances of the disclosed system in parallel or series to improve the results and offer additional flexibility.

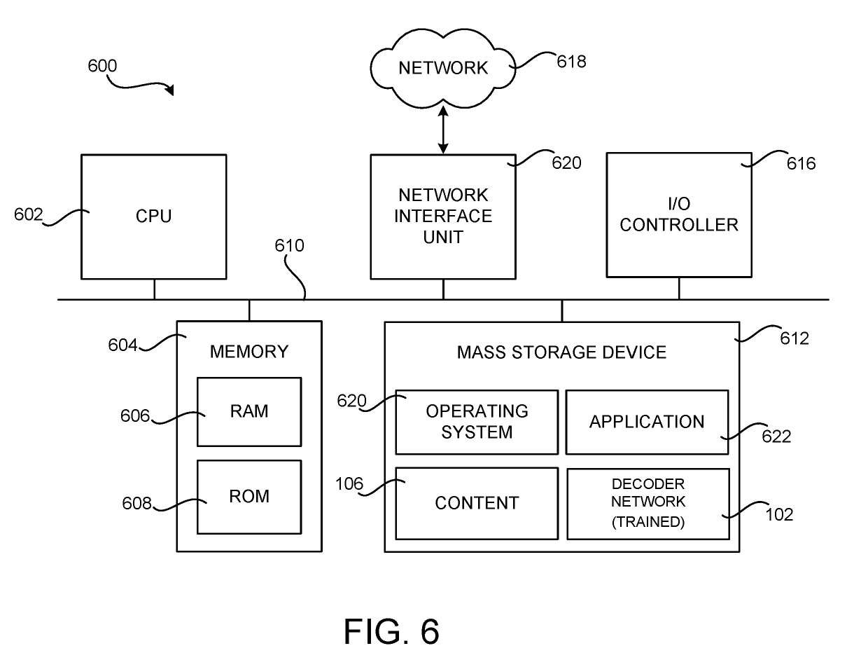

FIG. 6 is a computer architecture diagram that shows an architecture for a computer 600 capable of executing the software components described herein. The architecture illustrated in FIG. 6 is an architecture for a server computer, mobile phone, an e-reader, a smartphone, a desktop computer, a netbook computer, a tablet computer, a laptop computer, or another type of computing device suitable for executing the software components presented herein.

In this regard, it should be appreciated that the computer 600 shown in FIG. 6 can be utilized to implement a computing device capable of executing any of the software components presented herein. For example, and without limitation, the computing architecture described with reference to FIG. 6 can be utilized to implement the computing devices 104A and 104B illustrated in FIGS. 1 and 3 and described above, which are capable of executing the various software components described above.

The computer 600 illustrated in FIG. 6 includes a central processing unit 602 (“CPU”), a system memory 604, including a random-access memory 606 (“RAM”) and a read-only memory (“ROM”) 608, and a system bus 610 that couples the memory 604 to the CPU 602. A basic input/output system (“BIOS” or “firmware”) containing the basic routines that help to transfer information between elements within the computer 600, such as during startup, is stored in the ROM 608. The computer 600 further includes a mass storage device 612 for storing an operating system 820, application programs 822, and other types of programs including, but not limited to, the trained decoder network 102. The mass storage device 612 can also be configured to store other types of programs and data, such as the content 106.

The mass storage device 612 is connected to the CPU 602 through a mass storage controller (not shown) connected to the bus 610. The mass storage device 612 and its associated computer readable media provide non-volatile storage for the computer 600. Although the description of computer readable media contained herein refers to a mass storage device, such as a hard disk, CD-ROM drive, DVD-ROM drive, or USB storage key, it should be appreciated by those skilled in the art that computer readable media can be any available computer storage media or communication media that can be accessed by the computer 600.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner so as to encode information in the signal. By way of example, and not limitation, communication media includes wired media such as a wired network or direct-wired connection, and wireless media such as acoustic, radio frequency, infrared and other wireless media. Combinations of the any of the above should also be included within the scope of computer readable media.

By way of example, and not limitation, computer storage media can include volatile and non-volatile, removable and non-removable media implemented in any method or technology for storage of information such as computer readable instructions, data structures, program modules or other data. For example, computer storage media includes, but is not limited to, RAM, ROM, EPROM, EEPROM, flash memory or other solid-state memory technology, CD-ROM, digital versatile disks (“DVD”), HD-DVD, BLU-RAY, or other optical storage, magnetic cassettes, magnetic tape, magnetic disk storage or other magnetic storage devices, or any other medium that can be used to store the desired information and which can be accessed by the computer 600. For purposes of the claims, the phrase “computer storage medium,” and variations thereof, does not include waves or signals per se or communication media.

According to various configurations, the computer 600 can operate in a networked environment using logical connections to remote computers through a network such as the network 618. The computer 600 can connect to the network 618 through a network interface unit 820 connected to the bus 610. It should be appreciated that the network interface unit 820 can also be utilized to connect to other types of networks and remote computer systems. The computer 600 can also include an input/output controller 616 for receiving and processing input from a number of other devices, including a keyboard, mouse, touch input, or electronic stylus (not shown in FIG. 6). Similarly, the input/output controller 616 can provide output to a display screen or other type of output device (also not shown in FIG. 6).

It should be appreciated that the software components described herein, such as the encoder network 206 and the decoder network 102, when loaded into the CPU 602 and executed, can transform the CPU 602 and the overall computer 600 from a general-purpose computing device into a special-purpose computing device customized to facilitate the functionality presented herein. The CPU 602 can be constructed from any number of transistors or other discrete circuit elements, which can individually or collectively assume any number of states. More specifically, the CPU 602 can operate as a finite-state machine, in response to executable instructions contained within the software modules disclosed herein. These computer-executable instructions can transform the CPU 602 by specifying how the CPU 602 transitions between states, thereby transforming the transistors or other discrete hardware elements constituting the CPU 602.

Encoding the software modules presented herein can also transform the physical structure of the computer readable media presented herein. The specific transformation of physical structure depends on various factors, in different implementations of this description. Examples of such factors include, but are not limited to, the technology used to implement the computer readable media, whether the computer readable media is characterized as primary or secondary storage, and the like. For example, if the computer readable media is implemented as semiconductor-based memory, the software disclosed herein can be encoded on the computer readable media by transforming the physical state of the semiconductor memory. For instance, the software can transform the state of transistors, capacitors, or other discrete circuit elements constituting the semiconductor memory. The software can also transform the physical state of such components in order to store data thereupon.

As another example, the computer readable media disclosed herein can be implemented using magnetic or optical technology. In such implementations, the software presented herein can transform the physical state of magnetic or optical media, when the software is encoded therein. These transformations can include altering the magnetic characteristics of particular locations within given magnetic media. These transformations can also include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computer 600 in order to store and execute the software components presented herein. It also should be appreciated that the architecture shown in FIG. 6 for the computer 600, or a similar architecture, can be utilized to implement other types of computing devices, including hand-held computers, video game devices, embedded computer systems, mobile devices such as smartphones and tablets, and other types of computing devices known to those skilled in the art. It is also contemplated that the computer 600 might not include all of the components shown in FIG. 6, can include other components that are not explicitly shown in FIG. 6, or can utilize an architecture completely different than that shown in FIG. 6.

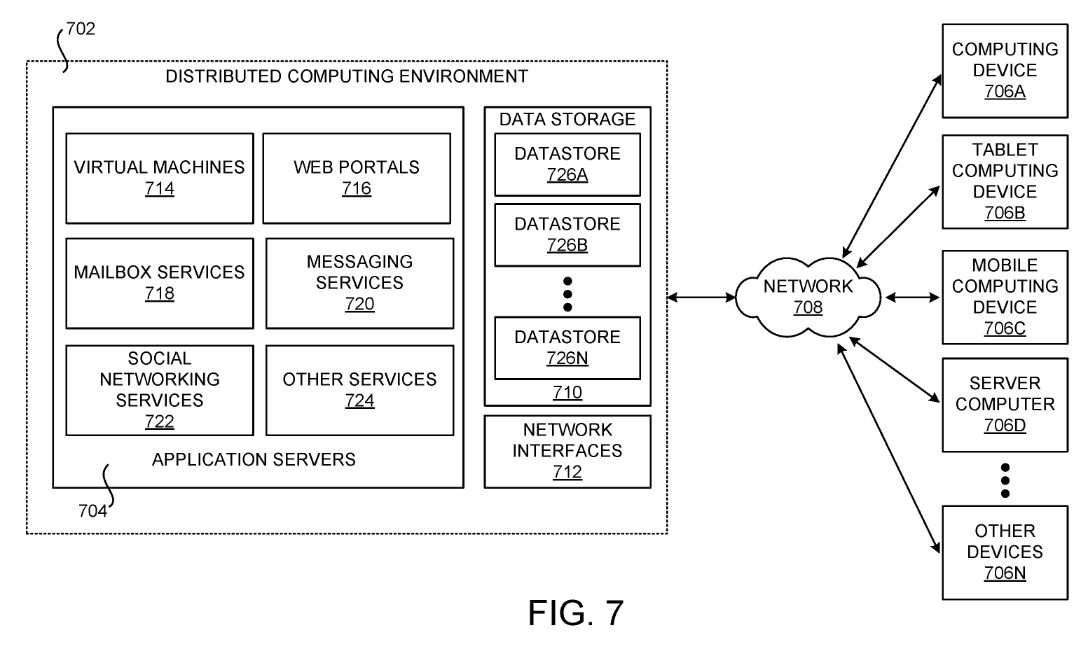

FIG. 7 shows aspects of an illustrative distributed computing environment 702 in which the software components described herein can be executed. Thus, the distributed computing environment 702 illustrated in FIG. 7 can be used to execute program code capable of providing the functionality described above with respect to FIGS. 1-5 and/or any of the other software components described herein.

According to various implementations, the distributed computing environment 702 operates on, in communication with, or as part of a network 708. One or more client devices 706A-706N (hereinafter referred to collectively and/or generically as “devices 706”) can communicate with the distributed computing environment 702 via the network 708 and/or other connections (not illustrated in FIG. 7).

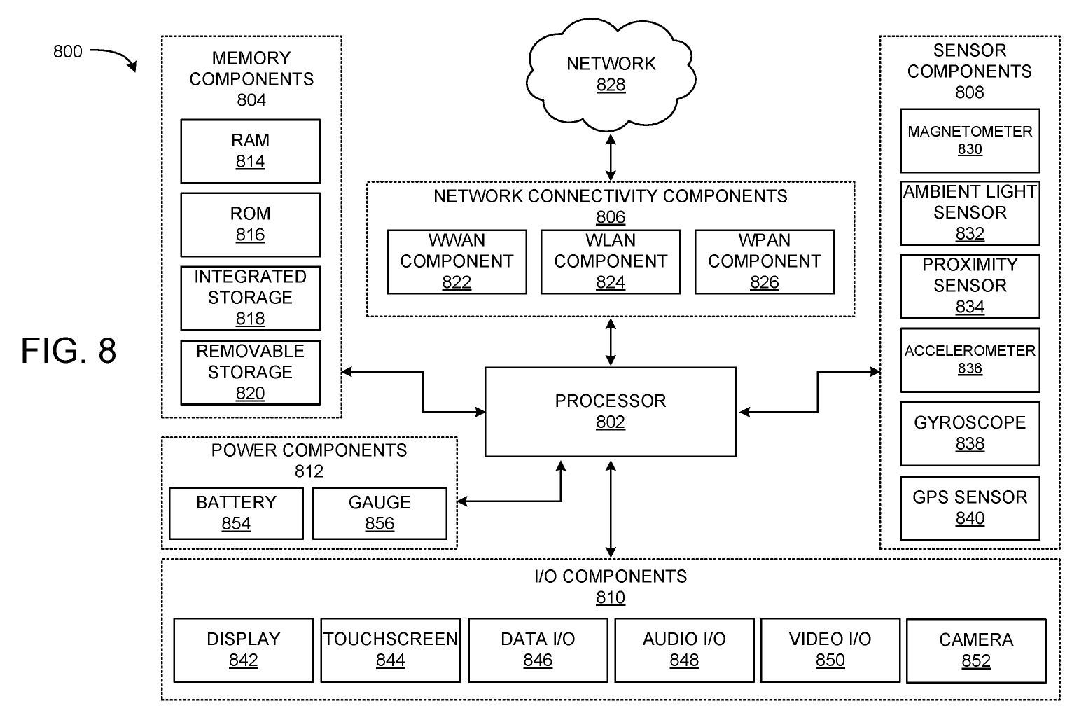

In the illustrated configuration, the devices 706 include: a computing device 706A such as a laptop computer, a desktop computer, or other computing device; a “slate” or tablet computing device (“tablet computing device”) 706B; a mobile computing device 706C such as a mobile telephone, a smartphone, or other mobile computing device; a server computer 706D; and/or other devices 706N. It should be understood that any number of devices 706 can communicate with the distributed computing environment 702. Two example computing architectures for the devices 706 are illustrated and described herein with reference to FIGS. 6 and 8. It should be understood that the illustrated clients 706 and computing architectures illustrated and described herein are illustrative and should not be construed as being limited in any way.

In the illustrated configuration, the distributed computing environment 702 includes application servers 704, data storage 710, and one or more network interfaces 712. According to various implementations, the functionality of the application servers 704 can be provided by one or more server computers that are executing as part of, or in communication with, the network 708. The application servers 704 can host various services such as virtual machines, portals, and/or other resources. In the illustrated configuration, the application servers 704 host one or more virtual machines 714 for hosting applications, such as program components for implementing the functionality described above with regard to FIGS. 1-5. It should be understood that this configuration is illustrative, and should not be construed as being limiting in any way. The application servers 704 might also host or provide access to one or more web portals, link pages, websites, and/or other information (“web portals”) 716.

According to various implementations, the application servers 704 also include one or more mailbox services 718 and one or more messaging services 720. The mailbox services 718 can include electronic mail (“email”) services. The mailbox services 718 can also include various personal information management (“PIM”) services including, but not limited to, calendar services, contact management services, collaboration services, and/or other services. The messaging services 720 can include, but are not limited to, instant messaging (“IM”) services, chat services, forum services, and/or other communication services.

The application servers 704 can also include one or more social networking services 722. The social networking services 722 can provide various types of social networking services including, but not limited to, services for sharing or posting status updates, instant messages, links, photos, videos, and/or other information, services for commenting or displaying interest in articles, products, blogs, or other resources, and/or other services. In some configurations, the social networking services 722 are provided by or include the FACEBOOK social networking service, the LINKEDIN professional networking service, the FOURSQUARE geographic networking service, and the like. In other configurations, the social networking services 722 are provided by other services, sites, and/or providers that might be referred to as “social networking providers.” For example, some websites allow users to interact with one another via email, chat services, and/or other means during various activities and/or contexts such as reading published articles, commenting on goods or services, publishing, collaboration, gaming, and the like. Other services are possible and are contemplated.

The social network services 722 can include commenting, blogging, and/or microblogging services. Examples of such services include, but are not limited to, the YELP commenting service, the KUDZU review service, the OFFICETALK enterprise microblogging service, the TWITTER messaging service, and/or other services. It should be appreciated that the above lists of services are not exhaustive and that numerous additional and/or alternative social networking services 722 are not mentioned herein for the sake of brevity. As such, the configurations described above are illustrative, and should not be construed as being limited in any way.

As also shown in FIG. 7, the application servers 704 can also host other services, applications, portals, and/or other resources (“other services”) 724. These services can include, but are not limited to, streaming video services like the NETFLIX streaming video service and productivity services such as the GMAIL email service from GOOGLE INC. It thus can be appreciated that activities performed by users of the distributed computing environment 702 can include various mailbox, messaging, social networking, group conversation, productivity, entertainment, and other types of activities. Use of these services, and others, can be detected and used to customize the operation of a computing device utilizing the technologies disclosed herein.

As mentioned above, the distributed computing environment 702 can include data storage 710. According to various implementations, the functionality of the data storage 710 is provided by one or more databases operating on, or in communication with, the network 708. The functionality of the data storage 710 can also be provided by one or more server computers configured to host data for the distributed computing environment 702. The data storage 710 can include, host, or provide one or more real or virtual datastores 726A-726N (hereinafter referred to collectively and/or generically as “datastores 726”). The datastores 726 are configured to host data used or created by the application servers 704 and/or other data.

The distributed computing environment 702 can communicate with, or be accessed by, the network interfaces 712. The network interfaces 712 can include various types of network hardware and software for supporting communications between two or more computing devices including, but not limited to, the devices 706 and the application servers 704. It should be appreciated that the network interfaces 712 can also be utilized to connect to other types of networks and/or computer systems.

It should be understood that the distributed computing environment 702 described herein can implement any aspects of the software elements described herein with any number of virtual computing resources and/or other distributed computing functionality that can be configured to execute any aspects of the software components disclosed herein. It should also be understood that the devices 706 can also include real or virtual machines including, but not limited to, server computers, web servers, personal computers, gaming consoles or other types of gaming devices, mobile computing devices, smartphones, and/or other devices. As such, various implementations of the technologies disclosed herein enable any device configured to access the distributed computing environment 702 to utilize the functionality described herein.

Turning now to FIG. 8, an illustrative computing device architecture 800 will be described for a computing device, such as the computing devices 104A and 104B, that is capable of executing the various software components described herein. The computing device architecture 800 is applicable to computing devices that facilitate mobile computing due, in part, to form factor, wireless connectivity, and/or battery-powered operation. In some configurations, the computing devices include, but are not limited to, mobile telephones, tablet devices, slate devices, portable video game devices, and the like.

The computing device architecture 800 is also applicable to any of the devices 706 shown in FIG. 7. Furthermore, aspects of the computing device architecture 800 are applicable to traditional desktop computers, portable computers (e.g., laptops, notebooks, ultra-portables, and netbooks), server computers, and other computer devices, such as those described herein. For example, the single touch and multi-touch aspects disclosed herein below can be applied to desktop, laptop, convertible, smartphone, or tablet computer devices that utilize a touchscreen or some other touch-enabled device, such as a touch-enabled track pad or touch-enabled mouse. The computing device architecture 800 can also be utilized to implement the computing devices 104A and 104B and/or other types of computing devices for implementing or consuming the functionality described herein.

The computing device architecture 800 illustrated in FIG. 8 includes a processor 802, memory components 804, network connectivity components 806, sensor components 808, input/output components 810, and power components 812. In the illustrated configuration, the processor 802 is in communication with the memory components 804, the network connectivity components 806, the sensor components 808, the input/output (“I/O”) components 810, and the power components 812. Although no connections are shown between the individual components illustrated in FIG. 8, the components can be connected electrically in order to interact and carry out device functions. In some configurations, the components are arranged so as to communicate via one or more busses (not shown).

The processor 802 includes one or more CPU cores configured to process data, execute computer-executable instructions of one or more application programs and to communicate with other components of the computing device architecture 800 in order to perform various functionality described herein. The processor 802 can be utilized to execute aspects of the software components presented herein and, particularly, those that utilize, at least in part, a touch-enabled input.

In some configurations, the processor 802 includes a graphics processing unit (“GPU”) configured to accelerate operations performed by the CPU, including, but not limited to, operations performed by executing general-purpose scientific and engineering computing applications, as well as graphics-intensive computing applications such as high-resolution video (e.g., 720P, 1080P, 4K, and greater), video games, 3D modeling applications, and the like. In some configurations, the processor 802 is configured to communicate with a discrete GPU (not shown). In any case, the CPU and GPU can be configured in accordance with a co-processing CPU/GPU computing model, wherein the sequential part of an application executes on the CPU and the computationally intensive part is accelerated by the GPU.

In some configurations, the processor 802 is, or is included in, a system-on-chip (“SoC”) along with one or more of the other components described herein below. For example, the SoC can include the processor 802, a GPU, one or more of the network connectivity components 806, and one or more of the sensor components 808. In some configurations, the processor 802 is fabricated, in part, utilizing a package-on-package (“PoP”) integrated circuit packaging technique. Moreover, the processor 802 can be a single core or multi-core processor.

The processor 802 can be created in accordance with an ARM architecture, available for license from ARM HOLDINGS of Cambridge, United Kingdom. Alternatively, the processor 802 can be created in accordance with an x86 architecture, such as is available from INTEL CORPORATION of Mountain View, Calif. and others. In some configurations, the processor 802 is a SNAPDRAGON SoC, available from QUALCOMM of San Diego, Calif., a TEGRA SoC, available from NVIDIA of Santa Clara, Calif., a HUMMINGBIRD SoC, available from SAMSUNG of Seoul, South Korea, an Open Multimedia Application Platform (“OMAP”) SoC, available from TEXAS INSTRUMENTS of Dallas, Tex., a customized version of any of the above SoCs, or a proprietary SoC.

The memory components 804 include a RAM 814, a ROM 816, an integrated storage memory (“integrated storage”) 818, and a removable storage memory (“removable storage”) 820. In some configurations, the RAM 814 or a portion thereof, the ROM 816 or a portion thereof, and/or some combination of the RAM 814 and the ROM 816 is integrated in the processor 802. In some configurations, the ROM 816 is configured to store a firmware, an operating system or a portion thereof (e.g., operating system kernel), and/or a bootloader to load an operating system kernel from the integrated storage 818 or the removable storage 820.

The integrated storage 818 can include a solid-state memory, a hard disk, or a combination of solid-state memory and a hard disk. The integrated storage 818 can be soldered or otherwise connected to a logic board upon which the processor 802 and other components described herein might also be connected. As such, the integrated storage 818 is integrated in the computing device. The integrated storage 818 can be configured to store an operating system or portions thereof, application programs, data, and other software components described herein.

The removable storage 820 can include a solid-state memory, a hard disk, or a combination of solid-state memory and a hard disk. In some configurations, the removable storage 820 is provided in lieu of the integrated storage 818. In other configurations, the removable storage 820 is provided as additional optional storage. In some configurations, the removable storage 820 is logically combined with the integrated storage 818 such that the total available storage is made available and shown to a user as a total combined capacity of the integrated storage 818 and the removable storage 820.

The removable storage 820 is configured to be inserted into a removable storage memory slot (not shown) or other mechanism by which the removable storage 820 is inserted and secured to facilitate a connection over which the removable storage 820 can communicate with other components of the computing device, such as the processor 802. The removable storage 820 can be embodied in various memory card formats including, but not limited to, PC card, COMPACTFLASH card, memory stick, secure digital (“SD”), miniSD, microSD, universal integrated circuit card (“UICC”) (e.g., a subscriber identity module (“SIM”) or universal SIM (“USIM”)), a proprietary format, or the like.

It can be understood that one or more of the memory components 804 can store an operating system. According to various configurations, the operating system includes, but is not limited to, the WINDOWS operating system from MICROSOFT CORPORATION, the IOS operating system from APPLE INC. of Cupertino, Calif., and ANDROID operating system from GOOGLE INC. of Mountain View, Calif. Other operating systems can also be utilized.

The network connectivity components 806 include a wireless wide area network component (“WWAN component”) 822, a wireless local area network component (“WLAN component”) 824, and a wireless personal area network component (“WPAN component”) 826. The network connectivity components 806 facilitate communications to and from a network 828, which can be a WWAN, a WLAN, or a WPAN. Although a single network 828 is illustrated, the network connectivity components 806 can facilitate simultaneous communication with multiple networks. For example, the network connectivity components 806 can facilitate simultaneous communications with multiple networks via one or more of a WWAN, a WLAN, or a WPAN.

The network 828 can be a WWAN, such as a mobile telecommunications network utilizing one or more mobile telecommunications technologies to provide voice and/or data services to a computing device utilizing the computing device architecture 800 via the WWAN component 822. The mobile telecommunications technologies can include, but are not limited to, Global System for Mobile communications (“GSM”), Code Division Multiple Access (“CDMA”) ONE, CDMA2000, Universal Mobile Telecommunications System (“UMTS”), Long Term Evolution (“LTE”), and Worldwide Interoperability for Microwave Access (“WiMAX”).

Moreover, the network 828 can utilize various channel access methods (which might or might not be used by the aforementioned standards) including, but not limited to, Time Division Multiple Access (“TDMA”), Frequency Division Multiple Access (“FDMA”), CDMA, wideband CDMA (“W-CDMA”), Orthogonal Frequency Division Multiplexing (“OFDM”), Space Division Multiple Access (“SDMA”), and the like. Data communications can be provided using General Packet Radio Service (“GPRS”), Enhanced Data rates for Global Evolution (“EDGE”), the High-Speed Packet Access (“HSPA”) protocol family including High-Speed Downlink Packet Access (“HSDPA”), Enhanced Uplink (“EUL”) or otherwise termed High-Speed Uplink Packet Access (“HSUPA”), Evolved HSPA (“HSPA+”), LTE, and various other current and future wireless data access standards. The network 828 can be configured to provide voice and/or data communications with any combination of the above technologies. The network 828 can be configured or adapted to provide voice and/or data communications in accordance with future generation technologies.

In some configurations, the WWAN component 822 is configured to provide dual-multi-mode connectivity to the network 828. For example, the WWAN component 822 can be configured to provide connectivity to the network 828, wherein the network 828 provides service via GSM and UMTS technologies, or via some other combination of technologies. Alternatively, multiple WWAN components 822 can be utilized to perform such functionality, and/or provide additional functionality to support other non-compatible technologies (i.e., incapable of being supported by a single WWAN component). The WWAN component 822 can facilitate similar connectivity to multiple networks (e.g., a UMTS network and an LTE network).

The network 828 can be a WLAN operating in accordance with one or more Institute of Electrical and Electronic Engineers (“IEEE”) 104.11 standards, such as IEEE 104.11a, 104.11b, 104.11g, 104.11n, and/or a future 104.11 standard (referred to herein collectively as WI-FI). Draft 104.11 standards are also contemplated. In some configurations, the WLAN is implemented utilizing one or more wireless WI-FI access points. In some configurations, one or more of the wireless WI-FI access points are another computing device with connectivity to a WWAN that are functioning as a WI-FI hotspot. The WLAN component 824 is configured to connect to the network 828 via the WI-FI access points. Such connections can be secured via various encryption technologies including, but not limited, WI-FI Protected Access (“WPA”), WPA2, Wired Equivalent Privacy (“WEP”), and the like.

The network 828 can be a WPAN operating in accordance with Infrared Data Association (“IrDA”), BLUETOOTH, wireless Universal Serial Bus (“USB”), Z-Wave, ZIGBEE, or some other short-range wireless technology. In some configurations, the WPAN component 826 is configured to facilitate communications with other devices, such as peripherals, computers, or other computing devices via the WPAN.

The sensor components 808 include a magnetometer 830, an ambient light sensor 832, a proximity sensor 834, an accelerometer 836, a gyroscope 838, and a Global Positioning System sensor (“GPS sensor”) 840. It is contemplated that other sensors, such as, but not limited to, temperature sensors or shock detection sensors, might also be incorporated in the computing device architecture 800.

The magnetometer 830 is configured to measure the strength and direction of a magnetic field. In some configurations, the magnetometer 830 provides measurements to a compass application program stored within one of the memory components 804 in order to provide a user with accurate directions in a frame of reference including the cardinal directions, north, south, east, and west. Similar measurements can be provided to a navigation application program that includes a compass component. Other uses of measurements obtained by the magnetometer 830 are contemplated.

The ambient light sensor 832 is configured to measure ambient light. In some configurations, the ambient light sensor 832 provides measurements to an application program stored within one the memory components 804 in order to automatically adjust the brightness of a display (described below) to compensate for low light and bright light environments. Other uses of measurements obtained by the ambient light sensor 832 are contemplated.

The proximity sensor 834 is configured to detect the presence of an object or thing in proximity to the computing device without direct contact. In some configurations, the proximity sensor 834 detects the presence of a user's body (e.g., the user's face) and provides this information to an application program stored within one of the memory components 804 that utilizes the proximity information to enable or disable some functionality of the computing device. For example, a telephone application program can automatically disable a touchscreen (described below) in response to receiving the proximity information so that the user's face does not inadvertently end a call or enable/disable other functionality within the telephone application program during the call. Other uses of proximity as detected by the proximity sensor 834 are contemplated.

The accelerometer 836 is configured to measure proper acceleration. In some configurations, output from the accelerometer 836 is used by an application program as an input mechanism to control some functionality of the application program. In some configurations, output from the accelerometer 836 is provided to an application program for use in switching between landscape and portrait modes, calculating coordinate acceleration, or detecting a fall. Other uses of the accelerometer 836 are contemplated.

The gyroscope 838 is configured to measure and maintain orientation. In some configurations, output from the gyroscope 838 is used by an application program as an input mechanism to control some functionality of the application program. For example, the gyroscope 838 can be used for accurate recognition of movement within a 3D environment of a video game application or some other application. In some configurations, an application program utilizes output from the gyroscope 838 and the accelerometer 836 to enhance user input operations. Other uses of the gyroscope 838 are contemplated.

The GPS sensor 840 is configured to receive signals from GPS satellites for use in calculating a location. The location calculated by the GPS sensor 840 can be used by any application program that requires or benefits from location information. For example, the location calculated by the GPS sensor 840 can be used with a navigation application program to provide directions from the location to a destination or directions from the destination to the location. Moreover, the GPS sensor 840 can be used to provide location information to an external location-based service, such as E911 service. The GPS sensor 840 can obtain location information generated via WI-FI, WIMAX, and/or cellular triangulation techniques utilizing one or more of the network connectivity components 806 to aid the GPS sensor 840 in obtaining a location fix. The GPS sensor 840 can also be used in Assisted GPS (“A-GPS”) systems.

The I/O components 810 include a display 842, a touchscreen 844, a data I/O interface component (“data I/O”) 846, an audio I/O interface component (“audio I/O”) 848, a video I/O interface component (“video I/O”) 850, and a camera 852. In some configurations, the display 842 and the touchscreen 844 are combined. In some configurations two or more of the data I/O component 846, the audio I/O component 848, and the video I/O component 850 are combined. The I/O components 810 can include discrete processors configured to support the various interfaces described below or might include processing functionality built-in to the processor 802.

The display 842 is an output device configured to present information in a visual form. In particular, the display 842 can present graphical user interface (“GUI”) elements, text, images, video, notifications, virtual buttons, virtual keyboards, messaging data, Internet content, device status, time, date, calendar data, preferences, map information, location information, and any other information that is capable of being presented in a visual form. In some configurations, the display 842 is a liquid crystal display (“LCD”) utilizing any active or passive matrix technology and any backlighting technology (if used). In some configurations, the display 842 is an organic light emitting diode (“OLED”) display. Other display types are contemplated.

The touchscreen 844 is an input device configured to detect the presence and location of a touch. The touchscreen 844 can be a resistive touchscreen, a capacitive touchscreen, a surface acoustic wave touchscreen, an infrared touchscreen, an optical imaging touchscreen, a dispersive signal touchscreen, an acoustic pulse recognition touchscreen, or can utilize any other touchscreen technology. In some configurations, the touchscreen 844 is incorporated on top of the display 842 as a transparent layer to enable a user to use one or more touches to interact with objects or other information presented on the display 842. In other configurations, the touchscreen 844 is a touch pad incorporated on a surface of the computing device that does not include the display 842. For example, the computing device can have a touchscreen incorporated on top of the display 842 and a touch pad on a surface opposite the display 842.

In some configurations, the touchscreen 844 is a single-touch touchscreen. In other configurations, the touchscreen 844 is a multi-touch touchscreen. In some configurations, the touchscreen 844 is configured to detect discrete touches, single touch gestures, and/or multi-touch gestures. These are collectively referred to herein as “gestures” for convenience. Several gestures will now be described. It should be understood that these gestures are illustrative and are not intended to limit the scope of the appended claims. Moreover, the described gestures, additional gestures, and/or alternative gestures can be implemented in software for use with the touchscreen 844. As such, a developer can create gestures that are specific to a particular application program.

In some configurations, the touchscreen 844 supports a tap gesture in which a user taps the touchscreen 844 once on an item presented on the display 842. The tap gesture can be used for various reasons including, but not limited to, opening or launching whatever the user taps, such as a graphical icon. In some configurations, the touchscreen 844 supports a double tap gesture in which a user taps the touchscreen 844 twice on an item presented on the display 842. The double tap gesture can be used for various reasons including, but not limited to, zooming in or zooming out in stages. In some configurations, the touchscreen 844 supports a tap and hold gesture in which a user taps the touchscreen 844 and maintains contact for at least a pre-defined time. The tap and hold gesture can be used for various reasons including, but not limited to, opening a context-specific menu.

In some configurations, the touchscreen 844 supports a pan gesture in which a user places a finger on the touchscreen 844 and maintains contact with the touchscreen 844 while moving the finger on the touchscreen 844. The pan gesture can be used for various reasons including, but not limited to, moving through screens, images, or menus at a controlled rate. Multiple finger pan gestures are also contemplated. In some configurations, the touchscreen 844 supports a flick gesture in which a user swipes a finger in the direction the user wants the screen to move. The flick gesture can be used for various reasons including, but not limited to, scrolling horizontally or vertically through menus or pages. In some configurations, the touchscreen 844 supports a pinch and stretch gesture in which a user makes a pinching motion with two fingers (e.g., thumb and forefinger) on the touchscreen 844 or moves the two fingers apart. The pinch and stretch gesture can be used for various reasons including, but not limited to, zooming gradually in or out of a website, map, or picture.

Although the gestures described above have been presented with reference to the use of one or more fingers for performing the gestures, other appendages such as toes or objects such as styluses can be used to interact with the touchscreen 844. As such, the above gestures should be understood as being illustrative and should not be construed as being limiting in any way.

The data I/O interface component 846 is configured to facilitate input of data to the computing device and output of data from the computing device. In some configurations, the data I/O interface component 846 includes a connector configured to provide wired connectivity between the computing device and a computer system, for example, for synchronization operation purposes. The connector can be a proprietary connector or a standardized connector such as USB, micro-USB, mini-USB, USB-C, or the like. In some configurations, the connector is a dock connector for docking the computing device with another device such as a docking station, audio device (e.g., a digital music player), or video device.

The audio I/O interface component 848 is configured to provide audio input and/or output capabilities to the computing device. In some configurations, the audio I/O interface component 848 includes a microphone configured to collect audio signals. In some configurations, the audio I/O interface component 848 includes a headphone jack configured to provide connectivity for headphones or other external speakers. In some configurations, the audio interface component 848 includes a speaker for the output of audio signals. In some configurations, the audio I/O interface component 848 includes an optical audio cable out.

The video I/O interface component 850 is configured to provide video input and/or output capabilities to the computing device. In some configurations, the video I/O interface component 850 includes a video connector configured to receive video as input from another device (e.g., a video media player such as a DVD or BLU-RAY player) or send video as output to another device (e.g., a monitor, a television, or some other external display). In some configurations, the video I/O interface component 850 includes a High-Definition Multimedia Interface (“HDMI”), mini-HDMI, micro-HDMI, DisplayPort, or proprietary connector to input/output video content. In some configurations, the video I/O interface component 850 or portions thereof is combined with the audio I/O interface component 848 or portions thereof.

The camera 852 can be configured to capture still images and/or video. The camera 852 can utilize a charge coupled device (“CCD”) or a complementary metal oxide semiconductor (“CMOS”) image sensor to capture images. In some configurations, the camera 852 includes a flash to aid in taking pictures in low-light environments. Settings for the camera 852 can be implemented as hardware or software buttons.

Although not illustrated, one or more hardware buttons can also be included in the computing device architecture 800. The hardware buttons can be used for controlling some operational aspect of the computing device. The hardware buttons can be dedicated buttons or multi-use buttons. The hardware buttons can be mechanical or sensor-based.

The illustrated power components 812 include one or more batteries 854, which can be connected to a battery gauge 856. The batteries 854 can be rechargeable or disposable. Rechargeable battery types include, but are not limited to, lithium polymer, lithium ion, nickel cadmium, and nickel metal hydride. Each of the batteries 854 can be made of one or more cells.

The battery gauge 856 can be configured to measure battery parameters such as current, voltage, and temperature. In some configurations, the battery gauge 856 is configured to measure the effect of a battery's discharge rate, temperature, age and other factors to predict remaining life within a certain percentage of error. In some configurations, the battery gauge 856 provides measurements to an application program that is configured to utilize the measurements to present useful power management data to a user. Power management data can include one or more of a percentage of battery used, a percentage of battery remaining, a battery condition, a remaining time, a remaining capacity (e.g., in watt hours), a current draw, and a voltage.

The power components 812 can also include a power connector (not shown), which can be combined with one or more of the aforementioned I/O components 810. The power components 812 can interface with an external power system or charging equipment via a power I/O component 810. Other configurations can also be utilized.

The disclosure presented herein also encompasses the subject matter set forth in the following clauses:

Clause 1. A computer-implemented method, comprising: training a decoder network to generate a first version of original content using latent vectors associated with the original content; causing the decoder network to be deployed to a computing device; following deployment of the decoder network to the computing device, transmitting the latent vectors associated with the original content and data defining a delta between the original content and the first version of the original content to the computing device; executing the decoder network at the computing device to generate the first version of the original content using the latent vectors associated with the original content; and applying the delta to the first version of the original content to generate a second version of the original content at the computing device.

Clause 2. The computer-implemented method of clause 1, wherein the decoder network is trained using a variational autoencoder generative adversarial network (“VAE-GAN”).

Clause 3. The computer-implemented method of any of clauses 1 or 2, further comprising training an encoder network to generate the latent vectors associated with the original content.

Clause 4. The computer-implemented method of any of clauses 1-3, wherein the latent vectors associated with the original content and the data defining the delta between the original content and the first version of the original content are generated in response to receiving a content request from the computing device.

Clause 5. The computer-implemented method of any of clauses 1-4, wherein the latent vectors associated with the original content and the data defining the delta between the original content and the first version of the original content are generated and stored prior to receiving a content request from the computing device.

Clause 6. The computer-implemented method of any of clauses 1-5, wherein the original content comprises at least one of an image, video, audio, or text.

Clause 7. The computer-implemented method of any of clauses 1-6, further comprising compressing the data defining the delta between the original content and the first version of the original content prior to transmitting the data to the computing device.

Clause 8. A first computing device comprising: one or more processors; and at least one computer storage medium having computer executable instructions stored thereon which, when executed by the one or more processors, cause the computing device to train a decoder network to generate a first version of original content using latent vectors associated with the original content; cause the decoder network to be deployed to a second computing device; generate data defining a delta between the original content and the first version of the original content; and transmit the latent vectors associated with the original content and the data defining the delta between the original content and the first version of the original content to the second computing device, wherein the second computing device executes the decoder network to generate the first version of the original content using the latent vectors and applies the delta to the first version of the original content to generate a second version of the original content.

Clause 9. The first computing device of clause 8, wherein the decoder network is trained using a variational autoencoder generative adversarial network (“VAE-GAN”).

Clause 10. The first computing device of any of clauses 8 or 9, wherein the at least one computer storage medium stores further computer executable instructions to train an encoder network to generate the latent vectors associated with the original content.

Clause 11. The first computing device of any of clauses 8-10, wherein the latent vectors associated with the original content and the data defining the delta between the original content and the first version of the original content are generated in response to receiving a content request from the second computing device.

Clause 12. The first computing device of any of clauses 8-11, wherein the latent vectors associated with the original content and the data defining the delta between the original content and the first version of the original content are generated and stored prior to receiving a content request from the second computing device.

Clause 13. The first computing device of any of clauses 8-12, wherein the original content comprises at least one of an image, video, audio, or text.

Clause 14. The first computing device of any of clauses 8-13, wherein the at least one computer storage medium stores further computer executable instructions to compress the data defining the delta between the original content and the first version of the original content prior to transmitting the data to the computing device.

Clause 15. A first computing device comprising: one or more processors; and at least one computer storage medium having computer executable instructions stored thereon which, when executed by the one or more processors, cause the computing device to receive latent vectors associated with original content; receive data defining a delta between the original content and a first version of the original content; execute a decoder network to generate the first version of the original content using the latent vectors at the first computing device; and apply the delta to the first version of the original content to generate a second version of the original content at the first computing device.

Clause 16. The first computing device of clause 15, wherein the decoder network is trained using a variational autoencoder generative adversarial network (“VAE-GAN”).

Clause 17. The first computing device of any of clauses 15 or 16, wherein an encoder network is trained to generate the latent vectors associated with the original content.

Clause 18. The first computing device of any of clauses 15-17, wherein the latent vectors associated with the original content and the data defining the delta between the original content and the first version of the original content are generated and stored by a second computing device prior to the transmission of a content request from the first computing device to the second computing device.

Clause 19. The first computing device of any of clauses 15-18, wherein the original content comprises at least one of an image, video, audio, or text.

Clause 20. The first computing device of any of clauses 15-19, wherein the data defining the delta between the original content and the first version of the original content is compressed, and wherein the at least one computer storage medium stores further computer executable instructions to decompress the data defining the delta between the original content and the first version of the original content prior to applying the delta to the first version of the original content to generate the second version of the original content.

Based on the foregoing, it should be appreciated that a machine learning system has been disclosed herein that is capable of reducing the network bandwidth required to transmit content between two computing devices. Although the subject matter presented herein has been described in language specific to computer structural features, methodological and transformative acts, specific computing machinery, and computer readable media, it is to be understood that the subject matter set forth in the appended claims is not necessarily limited to the specific features, acts, or media described herein. Rather, the specific features, acts and mediums are disclosed as example forms of implementing the claimed subject matter.

The subject matter described above is provided by way of illustration only and should not be construed as limiting. Various modifications and changes can be made to the subject matter described herein without following the example configurations and applications illustrated and described, and without departing from the scope of the present disclosure, which is set forth in the following claims.

What is claimed is:

1. A computer-implemented method, comprising:
training a decoder network to generate a first version of original content using latent vectors associated with the original content;
causing the decoder network to be deployed to a computing device;
following deployment of the decoder network to the computing device, transmitting the latent vectors associated with the original content and data defining a delta between the original content and the first version of the original content to the computing device;
executing the decoder network at the computing device to generate the first version of the original content using the latent vectors associated with the original content; and
applying the delta to the first version of the original content to generate a second version of the original content at the computing device.

2. The computer-implemented method of claim 1, wherein the decoder network is trained using a variational autoencoder generative adversarial network (“VAE-GAN”).

3. The computer-implemented method of claim 1, further comprising training an encoder network to generate the latent vectors associated with the original content.

4. The computer-implemented method of claim 1, wherein the latent vectors associated with the original content and the data defining the delta between the original content and the first version of the original content are generated in response to receiving a content request from the computing device.

5. The computer-implemented method of claim 1, wherein the latent vectors associated with the original content and the data defining the delta between the original content and the first version of the original content are generated and stored prior to receiving a content request from the computing device.

6. The computer-implemented method of claim 1, wherein the original content comprises at least one of an image, video, audio, or text.

7. The computer-implemented method of claim 1, further comprising compressing the data defining the delta between the original content and the first version of the original content prior to transmitting the data to the computing device.

8. A first computing device comprising:
one or more processors; and
at least one computer storage medium having computer executable instructions stored thereon which, when executed by the one or more processors, cause the computing device to
train a decoder network to generate a first version of original content using latent vectors associated with the original content;
cause the decoder network to be deployed to a second computing device;
generate data defining a delta between the original content and the first version of the original content; and
transmit the latent vectors associated with the original content and the data defining the delta between the original content and the first version of the original content to the second computing device, wherein the second computing device executes the decoder network to generate the first version of the original content using the latent vectors and applies the delta to the first version of the original content to generate a second version of the original content.

9. The first computing device of claim 8, wherein the decoder network is trained using a variational autoencoder generative adversarial network (“VAE-GAN”).

10. The first computing device of claim 8, wherein the at least one computer storage medium stores further computer executable instructions to train an encoder network to generate the latent vectors associated with the original content.

11. The first computing device of claim 8, wherein the latent vectors associated with the original content and the data defining the delta between the original content and the first version of the original content are generated in response to receiving a content request from the second computing device.

12. The first computing device of claim 8, wherein the latent vectors associated with the original content and the data defining the delta between the original content and the first version of the original content are generated and stored prior to receiving a content request from the second computing device.

13. The first computing device of claim 8, wherein the original content comprises at least one of an image, video, audio, or text.

14. The first computing device of claim 8, wherein the at least one computer storage medium stores further computer executable instructions to compress the data defining the delta between the original content and the first version of the original content prior to transmitting the data to the computing device.

15. A first computing device comprising:
one or more processors; and
at least one computer storage medium having computer executable instructions stored thereon which, when executed by the one or more processors, cause the computing device to
receive latent vectors associated with original content;
receive data defining a delta between the original content and a first version of the original content;
execute a decoder network to generate the first version of the original content using the latent vectors at the first computing device; and
apply the delta to the first version of the original content to generate a second version of the original content at the first computing device.

16. The first computing device of claim 15, wherein the decoder network is trained using a variational autoencoder generative adversarial network (“VAE-GAN”).

17. The first computing device of claim 15, wherein an encoder network is trained to generate the latent vectors associated with the original content.

18. The first computing device of claim 15, wherein the latent vectors associated with the original content and the data defining the delta between the original content and the first version of the original content are generated and stored by a second computing device prior to the transmission of a content request from the first computing device to the second computing device.

19. The first computing device of claim 15, wherein the original content comprises at least one of an image, video, audio, or text.

20. The first computing device of claim 15, wherein the data defining the delta between the original content and the first version of the original content is compressed, and wherein the at least one computer storage medium stores further computer executable instructions to decompress the data defining the delta between the original content and the first version of the original content prior to applying the delta to the first version of the original content to generate the second version of the original content.
